(19) United States
(12) Patent Application Publication
(10) Pub. No.: US 2019/0037667 A1
(43) Pub. Date: Jan. 31, 2019

(54) LIGHTING SYSTEM AND A METHOD OF CONTROLLING THE LIGHT OUTPUT FROM A LUMINAIRE

(71) Applicant: PHILIPS LIGHTING HOLDING B.V., EINDHOVEN (NL)

(72) Inventors: WEI PIEN LEE, EINDHOVEN (NL); HARRY BROERS, 'S-HERTOGENBOSCH (NL); RUBEN RAJAGOPALAN, NEUSS (DE)

(21) Appl. No.: 16/073,351

(22) PCT Filed: Jan. 24, 2017
(86) PCT No.: PCT/EP2017/051398

§ 371 Date: Jul. 27, 2018

Related U.S. Application Data
(60) Provisional application No. 62/288,496, filed on Jan. 29, 2016.

(30) Foreign Application Priority Data
Mar. 22, 2016 (EP) 16161500.0

(51) Int. Cl. H05B 37/02; G01N 21/55; G01J 1/42

(52) U.S. Cl. CPC H05B 37/0218; F21S 8/086; G01J 1/4204; G01N 21/55

(57) ABSTRACT

A lighting system comprises a light source such as a luminaire for illuminating a surface and a detector for detecting light reflected from the surface to generate a detection signal. The detection signal is processed for different illumination conditions of the surface and is adapted to derive reflectance distribution information in respect of the surface. The light source is controlled in dependence on the reflectance distribution information. The system thus includes a system for measuring surface reflectance by using a detector and observing the light reflectance from dynamic light sources.

### FIELD OF THE INVENTION

This invention relates to a lighting system and to a method of controlling the light output from a luminaire. In particular, it relates to a luminaire which can adjust its output based on determined reflectance properties of a surface being illuminated by the luminaire.

### BACKGROUND OF THE INVENTION

To ensure that an optimal lighting is delivered at a specific location or surface, knowledge about the surface reflectance is extremely significant. In general, when light interacts with matter, a complicated light-matter dynamic occurs. This interaction depends on the physical characteristics of the light as well as the physical composition and characteristics of the matter.

When light makes contact with a material, three types of interactions may occur: light reflection, light absorption, and light transmittance. That is, some of the incident light is reflected, some of the light is transmitted, and another portion of the light is absorbed by the medium itself Because light is a form of energy, conservation of energy tells us that the light incident at a surface is equal to the sum of the light reflected, the light absorbed and the light transmitted.

A bi-directional reflectance distribution function (BRDF) is a function which describes how much light is reflected when light makes contact with a certain material. In general, the degree to which light is reflected (or transmitted) depends on the viewer and light position relative to the surface normal and tangent.

The function takes an incoming light direction, and an outgoing light direction (taken in a coordinate system where the surface normal lies along the z-axis), and returns the ratio of reflected radiance exiting along the outgoing direction to the irradiance incident along the incoming direction.

Each direction is itself parameterized by an azimuth angle and a zenith angle. The BRDF as a whole is thus a function of 4 variables (the incident azimuth and zenith angles and the output azimuth and zenith angles). Other generalized models exist, that incorporate wavelength, positional variance, etc.

However, the basic four parameter BRDF function is assumed for the remainder of the document. It defines the reflectance between each possible incident direction and each possible reflection direction.

A number of approaches exist to estimate the BRDF ranging from theoretical and analytical models, to active measuring approaches, for example using gonioreflectometers.

The BRDF for a surface determines how the light will be reflected from the surface in response to a known input source of light.

This invention relates in particular to the use of reflectance information to control a luminaire light output. Known approaches to understand surface reflectance either rely on theoretical/analytical models that do not always simulate the real world accurately, or have complex measurement setups making them difficult to integrate into lighting systems.

### SUMMARY OF THE INVENTION

The invention is defined by the claims.

According to examples in accordance with an aspect of the invention, there is provided a lighting system comprising:

a light source, for illuminating a surface;

a detector for detecting light reflected from the surface to generate a detection signal;

a processor for processing the detection signal for different illumination conditions of the surface and adapted to derive reflectance distribution information in respect of the surface; and

a controller for controlling the light source in dependence on the reflectance distribution information.

The invention provides a lighting system including a light source such as a luminaire which includes a system for measuring surface reflectance by using a detector associated with the light source and observing the light reflectance from dynamic light sources.

One or more of the detector, processor and controller may be integrated with the light source as a combined module, or else one or more of the detector, processor and controller may be remote from the light source. The detector is preferably in close proximity to the light source, whereas the processing and controlling may be implemented anywhere.

The detector is for detecting light from the surface which may be natural light such as from the sun or moon as well as artificial light. When artificial light is detected, it may have originated from the light source of the lighting system and/or from other light sources in the vicinity of the lighting system.

The angle of incidence to the surface of the light which is later detected (after reflection) is known. This may be because the light is generated by a light source which is part of the system, or a light source which is part of a larger overall network, or it may because the position of the sun and moon are known, or it may be because the location of an external light source is detected, for example by image analysis.

The illumination conditions may be created by sunlight acting as a dynamic light source or else a controllable light source or light source array may be used.

The detector for example comprises a 1D sensor (a single photocell) or a 2D or 3D camera comprising a pixel array. The use of a pixel array enables a range of different angles of incidence to be processed.

The derived reflectance distribution information preferably comprises the bi-directional reflectance distribution function or a partial bi-directional reflectance distribution function.

The processor may be adapted to process the detection signal at different times of day and optionally also at different times of the year, which thereby have different natural illumination conditions. In this case, the illumination conditions may be caused by sunlight, so that no active light sources are needed for the measurement function.

The lighting system may comprise an array of light sources as one module (i.e. essentially at the same location for example part of a single luminaire), wherein the processor is adapted to control the array of light sources in a sequence to generate the different illumination conditions. In this case, the illumination is actively controlled the lighting used to provide the different illumination conditions is generated by the system itself rather than by an external uncontrolled source (like the sun). This has the advantage that both the intensity and position of the light is known.

The different illumination conditions are for the purposes of creating the detection signals.

The light source may instead or as well be a luminaire which is one luminaire in a network of luminaires, wherein the processor is adapted to process the detection signals for illumination generated by different luminaires of the network in the vicinity, which thereby create the different illumination conditions. In this way, the spatial separation between multiple luminaires may be used to create lighting effects which enable the reflectance function to be determined.

The detector may comprise a time-of-flight camera. This may for example enable an inclination of the surface being monitored to be determined.

The luminaire may be for illuminating a portion of a road, wherein the controller is for controlling the light source in dependence on the reflectance distribution information in order to reduce glare. This may involve controlling the intensity or the beam shape of the output from the luminaire.

Examples in accordance with another aspect of the invention provide a method of controlling the light output from a luminaire which is for illuminating a surface, comprising:

at the luminaire, detecting light reflected from the surface to generate detection signals;

processing the detection signals for different illumination conditions of the surface and deriving reflectance distribution information in respect of the surface; and

controlling the light output in dependence on the reflectance distribution information.

This method makes use of a detector which is part of a luminaire for determining surface reflectance properties, and these are used to control the light output.

The derived reflectance distribution information may comprise the bi-directional reflectance distribution function or a partial bi-directional reflectance distribution function.

The method may comprise processing the detection signal at different times of day and at different times of the year, which thereby have different natural illumination conditions.

Alternatively (or additionally) the method may comprise controlling an array of light sources of the luminaire in a sequence to generate the different illumination conditions.

The light source may comprise a luminaire which is one luminaire in a network of luminaires, wherein the method comprises processing the detection signal for illumination generated by different luminaires in the vicinity, which thereby create the different illumination conditions.

The detecting may comprise measuring a time-of-flight and a light intensity level.

The method may further comprise determining the location of an external light source, and using the detected light from the light source to enhance the derived reflectance distribution information in respect of the surface. In this way, multiple type of light source may be used to form the reflectance distribution information. There may for example be a primary light source (the sun, or a light source in the luminaire, or other luminaires in an array) and then additional external light sources may be used to enhance the distribution information. In this way, at least some of the gaps in a partial reflectance distribution model may be filled.

In one example the method is for illuminating a portion of a road, wherein the method comprises controlling the light source in dependence on the reflectance distribution information in order to reduce glare.

### BRIEF DESCRIPTION OF THE DRAWINGS

Examples of the invention will now be described in detail with reference to the accompanying drawings, in which:

FIG. 1 shows how the movement of the sun provides different reflection information to a static light sensor;

FIG. 2 shows a first example of a lighting control system;

FIG. 3 shows a second example of a lighting control system;

FIG. 4 shows a network of luminaires;

FIG. 5 shows how a pixelated light sensor may be used; and

FIG. 6 shows a general computer architecture which may be employed to perform the signal processing and control aspects of the system.

### DETAILED DESCRIPTION OF THE EMBODIMENTS

The invention provides a lighting system comprising a light source such as a luminaire, for illuminating a surface and a detector for detecting light reflected from the surface to generate a detection signal. The detection signal is processed for different illumination conditions of the surface and is adapted to derive reflectance distribution information in respect of the surface. The light source is controlled in dependence on the reflectance distribution information. The system thus includes a system for measuring surface reflectance by using a detector and observing the light reflectance from dynamic light sources.

The invention may be implemented using an existing luminaire infrastructure (optionally also making use of sunlight) to create an intelligent lighting infrastructure able to estimate surface reflectance. For example, repeated measurement of a BRDF may be made based on changes in surface properties due to variations in time/weather/usage.

A first example makes use of a natural light source as the illumination source. Natural light sources, namely sunlight and moonlight, have known movement patterns. A light detector integrated in an outdoor luminaire can thus estimate surface reflectance information over time based on illumination by sunlight or moonlight. Furthermore, repeated measurements at different seasons will result in richer distribution measurements, due to the different sub orbits.

If a camera with a pixel array is used as the detector, there is an advantage over a basic photocell that a camera can distinguish between the multiple reflectance angles due to the segmentation of the field-of-view by its sensor pixel resolution.

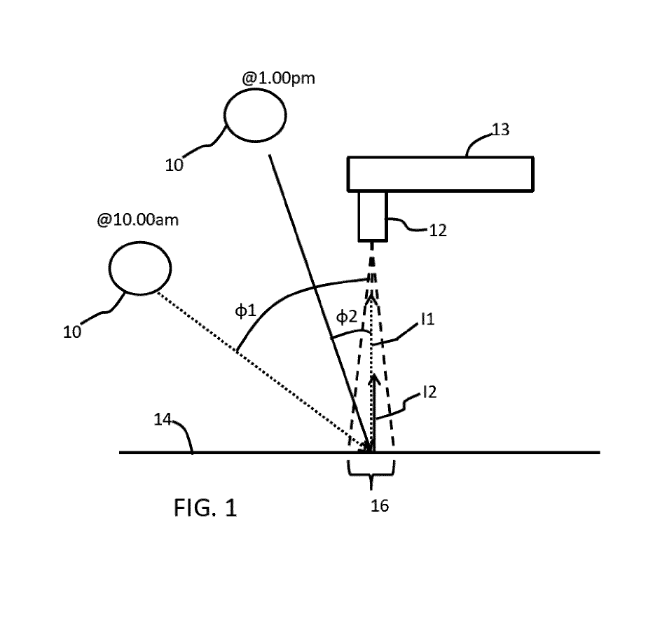

FIG. 1 shows the sun 10 at two different positions, at 10 am and at 1 pm. A light sensor 12 with a small field-of-view is mounted at a luminaire 13 and disposed above a surface 14 and receives reflections from a small area 16 of the surface 14. At 10 am, the light from the sun reaches the area 16 with an angle φ1 and at 1 pm the light from the sun reaches the area 16 with an angle φ2 with respect to the light direction from the area 16 to the light sensor 12. The reflected light reaching the light sensor 12 has a different intensity Il and 12.

The illumination area 16 is observed by the light sensor 12. The sun light as well as any other light (such as indoor office lighting) contributes to the observed light level. The contribution of both light sources can be retrieved by for example comparison of light levels with other light sources turned on or off.

Based on the time, the trajectory of the sun and the location of the luminaire, the location of the sun with respect to the observed area and thus the inclination angle φ can be computed. The measured contribution of sun light and its inclination angle with respect to the illumination area is collected over a longer period. The collected data is analyzed to estimate the BRDF of the surface.

The BRDF will only be a partial function in that the full possible range of angles of incidence will not have been tested. The obtained data may be extrapolated for example assuming a rotationally symmetric distribution, since only a line of reflectance values can be obtained for example from a single pass of the sun. This may be considered to generate a “partial” BRDF. However, even with a single sensor, asymmetry can be measured, for example a different curve for all “positive” incident angles compared to all “negative” incident angles.

When a sensor array is used, a small set of angles around a central incidence angle may be derived. This may for example indicate local asymmetry, and again this local asymmetry may be extrapolated to create a complete BRDF function.

There is a limited amount of data obtained, compared to a standard experimental procedure for measuring the BRDF function. To create a model from the limited data, a model fitting approach may be used, according to which parameter values may be obtained for which the known data points have minimum deviation with respect to the model instance.

For known reflection data, the same reflection characteristic arises if the light source and the light detector are interchanged. This approach can be used to extend the data set.

A partial model may be created, and this may then be matched with known BRDF models for certain materials or surfaces (tarmac, grass, concrete, carpet, wood, brick) to classify the material and then compensate the light based on the associated full BRDF of the material. Alternatively, a full BRDF function may be selected that resembles the most with the measured partial model.

Thus, instead of a parametric modeling approach, trained models/look up tables may be used, or else material classification may be employed.

In a parametric approach, by assuming a rotationally symmetric BRDF function, the model fitting requires a reduced number of parameters. The modeling may involve symmetry copying in combination with interpolation.

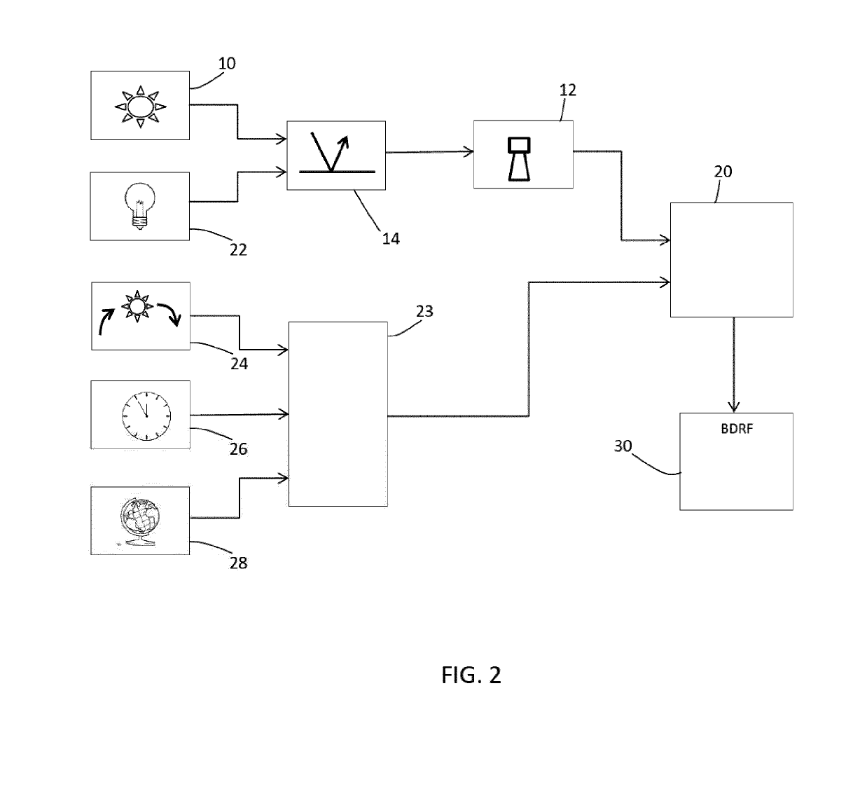

FIG. 2 shows an implementation of the system.

The sun 10 as well as other light sources 22 illuminate the target surface 14, which reflects light to the light sensor 12 which provides the light level to a first processor module 20.

Another processor module 23 (which of course may be the same physical system as the first processor module 20) calculates the relative location of the sun with respect to the surface. To do this, it receives as inputs the sun trajectory 24, a clock signal 26 and luminaire position and orientation information 28. The luminaire position and orientation may be generated as an input for the control system by a system commissioning body. Alternatively, the luminaire may detect its own position for example using a GPS system. The inclination angle of the sunlight is provided to the first processor module 20.

The first processor module 20 then derives an estimation of the BRDF as output 30.

This output 30 is used to control the light output from the luminaire 13, at which the light sensor 12 is located.

An example will be described in more detail in which the luminaire 13 is a street lighting downlight.

By using a light sensor 12 with a small field-of-view (FOV), the spread of the reflection angle can be neglected. Alternatively, an array of multiple light sensors may be used, such as a small matrix array of light sensors, to obtain more detailed data. A camera may for example be used with pixel coordinates that are related to the reflection angle.

The measurements obtained by the image sensor are time stamped (i.e., with a time of day as well as date), since time synchronization is required with the slow movement of the sun.

The luminaire location 28 may be a geometric location which will be fixed for a fixed sensor and luminaire.

The system may also receive as input the weather conditions, for example from a web service, to identify when it is cloudy or overcast for example. There may instead be sensors for determining the weather conditions. In this way, not only a sun inclination angle is provided, but also a compensation factor to take account of the weather conditions.

The incident angle is derived based on the assumption that the surface is parallel the earth's surface, with the earth represented by a perfect sphere. The sensor is assumed to be aligned with the surface normal. These assumptions simplify the data processing functions. A longitude-latitude coordinate system may for example be used to define the surface.

The sensed light level provided to the first processor module 20 can thus be associated with a pair of incident and reflection angles. This data is then stored in a database and extended when measuring over a longer time, since the sun's orbit changes over the seasons. The measurements may be compensated for the light intensity fall off of the sun across the day and seasons. This may for example be implemented using a look up table.

The data is used to create a robust partial BRDF.

When data is collected for a few consecutive days, the orbit of the sun is very similar and can be considered to be the same. From a database or from local weather sensors, it is known when it was cloudy or raining, which will have an effect on the measurements. The resulting measurement contributions can be weighted differently or even disregarded completely.

A BRDF is then derived based on compensated data instead of raw data. This functions as a reference value for the surface properties. Similar data entries (i.e. for the same incidence angle) can be provided into corresponding bins and then can be averaged or processed using outlier filtering strategies.

The BRDF data derived may be used in different ways. A broader and wider spread distribution indicates a more diffuse surface which indicates that the reflections of the luminaire will be less annoying. If there is an indication that the BRDF is not rotation symmetric then for some reason the surface is somehow anisotropic to light. The light beam profile could then be adjusted to take account of the detected distribution to reduce the negative reflection effects only where necessary. There are various other reasons as to why a BRDF may be asymmetric e.g. the surface is sloped. The lighting can be adjusted by turning the light away from the angle where the peak is in the distribution. In this case, the rotational orientation (around the sensor view direction axis) should be known or a matrix of sensors or pixelated camera should be used instead. This enables the BRDF orientation to be linked to the luminaire orientation.

The light intensity output from a luminaire may be decreased to reduce the effect of unwanted reflections. The light intensity in a lighting network (e.g. a whole street) may for example be coordinated according to a detected position of a person or vehicle car. In a network of luminaires, based on the BRDF information for the locally illuminated surfaces, luminaires may be identified which have unwanted reflections. The light intensity may then be narrowed to reduce reflection effects. For luminaires which are along a one-way street, the light beam may be turned away from the incoming traffic direction.

A central data aggregation in respect of multiple luminaires may provide insight of a complete road or district. Collective light intensity management could then lead to power savings.

The BRDF for a surface may change over time. A currently obtained BRDF may be compared to previous historical information. Changes of surface properties may arise for example due to wear, and these may be analyzed so that the light beam or angle is adjusted over time. Changes may also arise due to the presence of surface debris, such as blown sand, or due to changing weather conditions such as rain. Depending for example on the color of sand which is present, the light intensity can be adjusted to assure proper lighting.

A second example makes use of active illumination. FIG. 3 shows an example in which active lighting is provided and there is also the use of a time-of-flight camera.

The target surface is illuminated by an active light source 40 as well as other light sources 22 (such as ambient light), which reflect light to the light sensor 12 in the form of a time-of-flight camera. The camera 12 provides the light level to the first processor module 20 but it also provides range information to a third processor module 42 which derives surface orientation information. This surface orientation information is provided to the first processing module 20 which then derives the angle of incidence relative to the surface.

Thus, the advantage of using a time-of-flight camera is that the solution can provide the distance and orientation of the illumination surface. Instead of assuming that the illumination area is horizontal, the actual orientation of surfaces can be used to get a more accurate BRDF estimation.

The use of a time-of-flight camera in a reflectance capture system is disclosed in the article “Single View Reflectance Capture using Multiplexed Scattering and Time-of-flight Imaging” of Nikhil Naik et. al., in the SIGGRAPH Asia 2011 proceedings. The use of a time-of-flight camera enables multiple space-time images to be obtained such that images captured at different points of time represent different light paths, and therefore different incident and reflection angles, between the illumination source and the detector.

The contribution of the active light source may be retrieved by comparison of light levels with the active illumination on or off. From the range data provided by the time of camera 12 the distance to the illumination area and the surface orientation can be retrieved.

For each camera pixel the inclination angle of the light source with the surface is known and the reflected light measured. The pixels observing a different part of the illuminated area but in case of a homogenous surface the optical properties will be similar. The measured contribution of the active light and its inclination angle with respect to the illumination area is used to estimate the BRDF and provide the BRDF output 30.

Known time-of-flight cameras use dedicated active illumination. However, a luminaire light source may be used for the time-of-flight active illumination source.

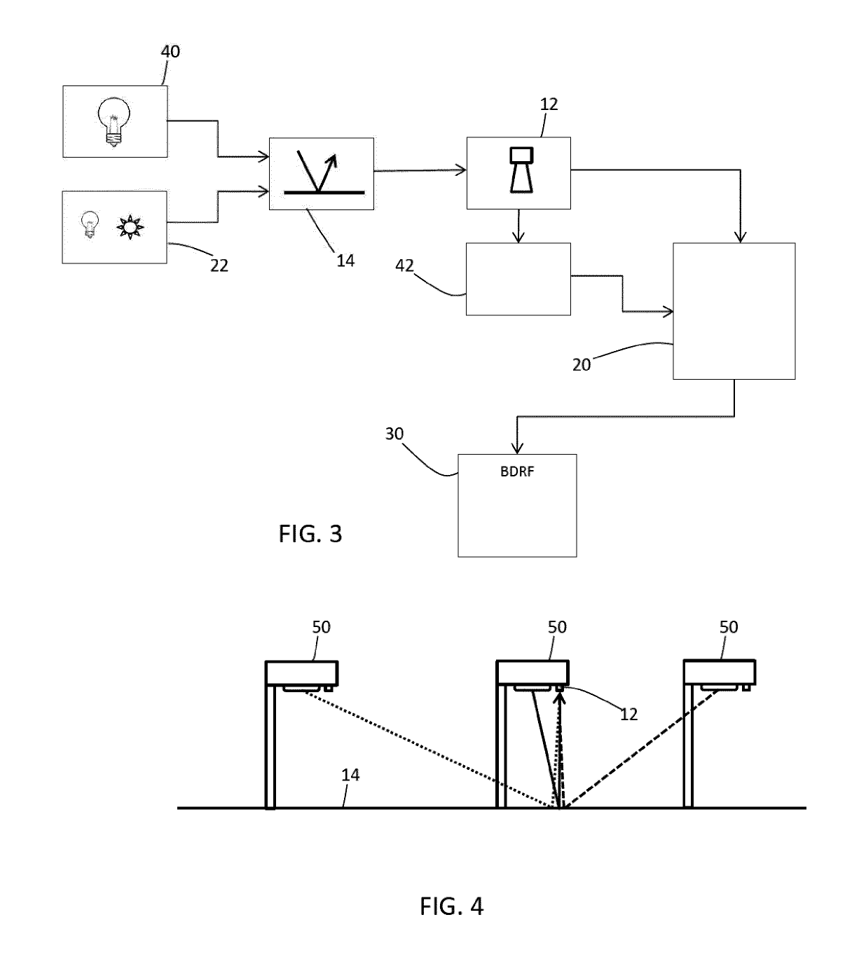

FIG. 4 shows a network of luminaries 50. Neighboring light sources are used to emit light onto the surface to be characterized with different incident angles, to estimate the surface reflectance model. Neighboring luminaires may be used for constructing the BRDF when the spatial relation between luminaires is known.

When an active light source is used in combination with a camera sensor (or photocell) each pixel element of the camera receives reflected light with a different incident angle. This information can be used to estimate at least a partial surface reflectance model. Time-of-flight cameras may already be integrated into luminaires for activity monitoring (presence detection and other context features). As explained above, these can also be used to derive inclination information, i.e. the direction of the surface normals. The advantage of using active illumination instead of relying purely on natural light sources is that the additional information of the surface normals can be used to improve the BRDF.

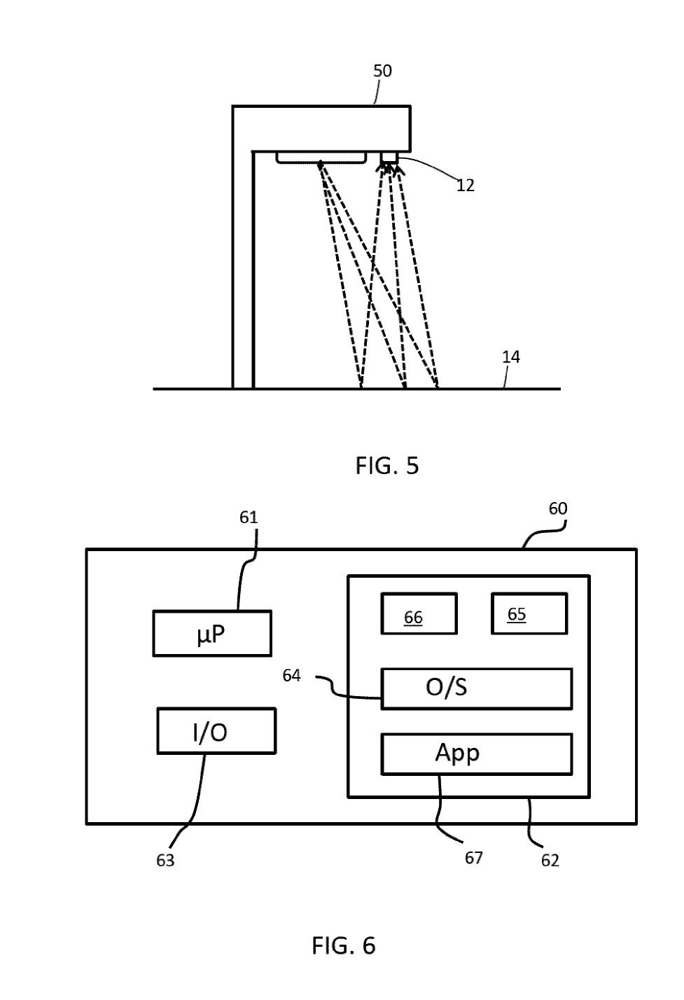

FIG. 5 shows a luminaire with a pixelated camera 12. Different pixels receive light from different regions of the surface 14. In this way, active illumination of a 2D or 3D camera system is able to create different incident angles for each pixel of the image sensor. Thus, the reflected light for multiple inclination angles with respect to the surface can be measured instead of a single light level value.

In a simplest implementation of the invention, the indoor or outdoor luminaire includes a photocell which monitors the reflectance of the sun at a specific region in its field-of-view, and accordingly determines the optimal light setting for that region.

In a more complex implementation, a network of luminaires is provided with associated photocells that monitor the reflectance of each individual luminaire at a specific region in its field-of-view. The incident angle of the emitted light from an individual luminaire can be computed from known the overall luminaire topology.

By replacing single-element photocells with an image sensor with a matrix of photo-sensitive elements, such as a camera or 3D camera, more data can be collected. For each pixel element, a BRDF can be reconstructed. This can be used to estimate the BRDF of different area within the field-of-view or to provide a more accurate estimate of an overall BRDF.

The active illumination may use a dedicated illumination source in a luminaire or it may use the normal luminaire output. Active illumination may already be required for presence detection in low light conditions or for time-of-flight range sensing, and this illumination can be reused to create light with different incident angles to estimate the BRDF.

For road lighting application, in case of rain the BRDF of a road will change. In this situation the light projection (shape, intensity) can be adapted to minimize the amount of glare for road users. Conversely, monitoring the BRDF can be used to detect rain.

The lighting control may also be based on the location of people (or vehicles) with respect to the light sources and the BRDF of the lighting areas. The contribution of individual luminaries can thus be tuned to minimize the amount of glare while providing sufficient illumination.

Additional refinements may make use of artificial moving light lights such as car headlights. With simple assumptions (e.g. sensor height, headlight height, relatively flat surface) the light source can be localized and therefore the BRDF function expanded with complementary incident angles that otherwise cannot be used based on illumination from the luminaire or from neighboring luminaires or indeed from the passage of the sun.

When using camera images, the location of cars can be retrieved. Also, the location of the sun could be retrieved from cast shadows. This may provide validation of the expected sun position from time analysis. In this way, image analysis is used to measure the location of the light source to give an indication of the angle of inclination.

In general, any external light source may be used if its location (and therefore position relative to the system) can be detected. For example, external light sources may be in use to illuminate the area. For example, position-aware drones may be fitted with lights, or light sources may be manually moved or carried around to scan specific zones. The specific computed 3D trajectory of the light source may be used to complete or expand the BRDF. In this way, additional external light sources may be analyzed in order to fill the gaps of a previously computed sub-optimal BRDF.

In a simplest approach, during darkness a single light source may be made to follow a known trajectory in the vicinity of the luminaire. By suitable subtraction of any reflected light observed with the light source turned off, the contribution of the light source to the received reflected signal can be derived. The light source may be fitted with a positioning system, so that the system instructs the light source to be positioned at a certain position and emit light of a certain intensity during an installation procedure. This positioning may be achieved manually (by a system installer) or automatically (for example using a drone which carries a light source). Essentially, any light source having a known location and contribution to the incident detected reflected light may be used to enhance (or indeed build) the reflectance distribution pattern.

In a controlled calibration process, a single light source may be provided in an otherwise dark environment as explained above. This makes the signal processing more robust. In a real-time information gathering process, there may be many light sources, some static and some dynamic. Static light sources can be removed from the computations by suitable signal processing, by analyzing changes in the reflected signal. Dynamic light sources (such as car headlights) may be tracked by image processing techniques so that their different contributions to the received reflected light can be determined by regression analysis. Of course, for the timescale of analyzing the light from a passing car, the sun position and weather conditions may be treated as static. There may be other static light sources which are also static over such a time frame, such as building lighting. Thus, even by day, the contribution of static light sources may be cancelled so that dynamic light sources may be identified, which are either part of an installation procedure or are external light sources.

A light source intensity for different types of external light source (such as car headlights) may be assumed or derived from data collected over time.

Clearly, the fewer the number of dynamic light sources, the easier is the processing to derive the contribution of each individual light source to the received reflected signal. As soon as the contribution of an individual light source of known position (and known or assumed intensity) can be determined, the reflectance function may be updated based on information concerning that particular angle of incidence.

By determining the location of an external secondary light source which is additional to a main primary source used to provide the different illumination conditions (the sun, or a light source in the luminaire, or other luminaires in an array) the derived reflectance distribution information in respect of the surface may be expanded. In this way, multiple types of light source may be used to form the reflectance distribution information over time.

The examples above have been explained with reference to an outdoor road lighting application. However, the invention may be applied to indoor lighting. Thus, the illumination source may comprise networked office lighting. When using a lighting infrastructure as the light source, the inclination angles of the light sources with respect to a given light sensor is known a priori since the topology of the lighting network is known.

As explained above, one more processors are used to analyze the collected light sensor data and provide control of the luminaires. FIG. 6 illustrates an example of a computer 60 for implementing the processors/controllers described above.

The computer may be remote from the luminaires, as part of a central control system, or else it may be local to the luminaire being controlled.

The computer 60 includes, but is not limited to, PCs, workstations, laptops, PDAs, palm devices, servers, storages, and the like. Generally, in terms of hardware architecture, the computer 60 may include one or more processors 61, memory 62, and one or more I/O devices 63 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 61 is a hardware device for executing software that can be stored in the memory 62. The processor 61 can be virtually any custom made or commercially available processor, a central processing unit (CPU), a digital signal processor (DSP), or an auxiliary processor among several processors associated with the computer 60, and the processor 61 may be a semiconductor based microprocessor (in the form of a microchip) or a microprocessor.

The memory 62 can include any one or combination of volatile memory elements (e.g., random access memory (RAM), such as dynamic random access memory (DRAM), static random access memory (SRAM), etc.) and non-volatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 62 may incorporate electronic, magnetic, optical, and/or other types of storage media. Note that the memory 62 can have a distributed architecture, where various components are situated remote from one another, but can be accessed by the processor 61.

The software in the memory 62 may include one or more separate programs, each of which comprises an ordered listing of executable instructions for implementing logical functions. The software in the memory 62 includes a suitable operating system (O/S) 64, compiler 65, source code 66, and one or more applications 67 in accordance with exemplary embodiments.

The application 67 comprises numerous functional components such as computational units, logic, functional units, processes, operations, virtual entities, and/or modules.

The operating system 64 controls the execution of computer programs, and provides scheduling, input-output control, file and data management, memory management, and communication control and related services.

Application 67 may be a source program, executable program (object code), script, or any other entity comprising a set of instructions to be performed. When a source program, then the program is usually translated via a compiler (such as the compiler 65), assembler, interpreter, or the like, which may or may not be included within the memory 62, so as to operate properly in connection with the operating system 64. Furthermore, the application 67 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, JavaScript, FORTRAN, COBOL, Perl, Java, ADA, .NET, and the like.

The I/O devices 63 may include input devices such as, for example but not limited to, a mouse, keyboard, scanner, microphone, camera, etc. Furthermore, the I/O devices 63 may also include output devices, for example but not limited to a printer, display, etc. Finally, the I/O devices 63 may further include devices that communicate both inputs and outputs, for instance but not limited to, a network interface controller (NIC) or modulator/demodulator (for accessing remote devices, other files, devices, systems, or a network), a radio frequency (RF) or other transceiver, a telephonic interface, a bridge, a router, etc. The I/O devices 63 also include components for communicating over various networks, such as the Internet or intranet.

When the computer 60 is in operation, the processor 61 is configured to execute software stored within the memory 62, to communicate data to and from the memory 62, and to generally control operations of the computer 60 pursuant to the software. The application 67 and the operating system 64 are read, in whole or in part, by the processor 61, perhaps buffered within the processor 61, and then executed.

When the application 67 is implemented in software it should be noted that the application 67 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

The invention may be used in lighting design and commissioning solutions for professional and consumer lighting applications.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting system comprising:
a light source, for illuminating a surface;
a detector for detecting light reflected from the surface to generate a detection signal;
a processor for processing the detection signal for different illumination conditions of the surface and adapted to derive reflectance distribution information in respect of the surface; and
a controller for controlling the light source in dependence on the reflectance distribution information,
wherein the processor is adapted to process the detection signal at different times of day and optionally also at different times of the year, which thereby have different natural illumination conditions, and
wherein the detection signal is received by the processor from the detector or retrieved by the processor from a memory.

2. A lighting system as claimed in claim 1, wherein the derived reflectance distribution information comprises the bi-directional reflectance distribution function or a partial bi-directional reflectance distribution function.

3. (canceled)

4. A lighting system as claimed in claim 1, comprising an array of light sources, wherein the processor is adapted to control the array of light sources in a sequence to generate the different illumination conditions for detection.

5. A lighting system as claimed in wherein the light source is one luminaire in a network of luminaires, wherein the processor is adapted to process the detection signals resulting from illumination generated by different luminaires of the network in the vicinity, which thereby create the different illumination conditions.

6. A lighting system as claimed in claim 1, wherein the detector comprises a 1D sensor, or a 2D or 3D camera comprising a pixel array or a time-of-flight camera.

7. A lighting system as claimed in claim 1, for illuminating a portion of a road, wherein the controller is for controlling the light source in dependence on the reflectance distribution information in order to reduce glare.

8. A method of controlling the light output from a luminaire which is for illuminating a surface, comprising:
at the luminaire, detecting light reflected from the surface to generate detection signals;
processing the detection signals for different illumination conditions of the surface and deriving reflectance distribution information in respect of the surface; and
controlling the light output in dependence on the reflectance distribution information,
wherein the processing of the detection signal occurs at different times of day and optionally also at different times of the year, which thereby have different natural illumination conditions.

9. A method as claimed in claim 8, wherein the derived reflectance distribution information comprises the bi-directional reflectance distribution function or a partial bi-directional reflectance distribution function.

10. (canceled)

11. A method as claimed in claim 8, comprising controlling an array of light sources of the luminaire in a sequence to generate the different illumination conditions.

12. A method as claimed in claim 8, wherein the luminaire comprises one luminaire in a network of luminaires, wherein the method comprises processing the detection signal for illumination generated by different luminaires in the vicinity, which thereby create the different illumination conditions.

13. A method as claimed in claim 8, wherein the detecting comprises measuring a time-of-flight and a light intensity.

14. A method as claimed in claim 8, further comprising determining the location of an external light source, and using the detected light from the light source to enhance the derived reflectance distribution information in respect of the surface.

15. A method as claimed in claim 8, for illuminating a portion of a road, wherein the method comprises controlling the light source in dependence on the reflectance distribution information in order to reduce glare.
